(19) United States
(12) Patent Application Publication
(10) Pub. No.: US 2026/0214531 A1
(43) Pub. Date: Jul. 23, 2026

(54) MEASUREMENT CONFIGURATION IN A RADIO ACCESS NETWORK

(71) Applicant: Nokia Technologies Oy, Espoo (FI)

(72) Inventors: Sanjay GOYAL, Murray Hill, NJ (US); Srinivasan SELVAGANAPATHY, Bangalore (IN); Timo KOSKELA, Oulu (FI); Umur KARABULUT, Munich (DE); Keeth Saliya Jayasinghe LADDU, Espoo (FI); Panagiotis SPAPIS, Munich (DE)

(21) Appl. No.: 19/143,971

(22) PCT Filed: Jan. 16, 2024
(86) PCT No.: PCT/EP2024/050893

§ 371 Date: Jun. 27, 2025

(30) Foreign Application Priority Data
Feb. 17, 2023 (IN) 202341010904

(51) Int. Cl. H04W 36/00

(52) U.S. Cl. CPC H04W 36/0085

(57) ABSTRACT

Described herein is a user equipment, UE, configured for supporting connection towards a radio access network including e.g. a DU and a CU. The UE sends a measurement report comprising information indicative of at least one target cell of the at least one neighboring target cell to the CU, and receive, from the CU, a configuration message comprising information indicative of a LTM measurement related configuration, wherein the LTM measurement related configuration comprises a resource related configuration for at least one of the serving cell the UE is connected to and one target cell the UE as candidate cell to perform a cell change to, and cell-specific LTM reporting related configuration. The UE performs measurements and report measurements related information based on at least part of the received LTM measurement related configuration. The report is preferably send to the DU. The UE may receive updated LTM measurement related configuration from the DU.

### TECHNOLOGY

The present disclosure relates to mobility aspects in a radio access network, in particular (Layer 1/Layer 2) L1L2-triggered mobility, LTM, and in particular to measurement configurations.

### BACKGROUND

Any discussion of the background art throughout the specification should in no way be considered as an admission that such art is widely known or forms part of common general knowledge in the field.

Broadly speaking, for L1L2-triggered mobility (LTM), the UE reports L1 beam measurements to the serving DU (i.e., the source DU) and the serving source DU can decide when to trigger the handover to one or more candidate target cells which are indicated with the L1 measurement report provided by the UE based on that previous L3 measurement values provided by the UE have indicated that those one or more candidate target cells are determined as being suitable cells to which the UE can be handed over.

Related to Layer 1 (L1) measurements and reporting for Rel-18 L1/2-triggered mobility (LTM):
e.g. RRC IEs for CSI Measurements and Reporting [3GPP TS 38.331] include:

### CSI-MeasConfig

The IE CSI-MeasConfig is used to configure CSI-RS (reference signals) belonging to the serving cell in which CSI-MeasConfig is included, channel state information reports to be transmitted on PUCCH on the serving cell in which CSI-MeasConfig is included and channel state information reports on PUSCH triggered by DCI received on the serving cell in which CSI-MeasConfig is included.

### CSI-ReportConfig

The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). It provides the information on reference signals (CSI-RSs) to be measured for the configured report)

### CSI-ResourceConfig

The IE CSI-ResourceConfig defines a group of one or more NZP-CSI-RS-ResourceSet, CSI-IM-ResourceSet and/or CSI-SSB-ResourceSet.

### CSI-SSB-ResourceSet

The IE CSI-SSB-ResourceSet is used to configure one SS/PBCH block resource set which refers to SS/PBCH as indicated in ServingCellConfigCommon and ServingCellConfig. With Release-17 inter-cell beam management (ICBM) enhancements, it may include SSBs from other cells (although intra-DU), by providing associated PCI info in the form of ServingAdditionalPCIIndex-r17. The mapping between the PCI and ServingAdditionalPCIIndex-r17 can be found in SSB-MTC-AdditionalPCI-r17.

### SSB-MTC-AdditionalPCI-r17

SSB-MTC-AdditionalPCI-r17 is used to configure measurement timing configurations, i.e., timing occasions at which the UE measures SSBs of configured cells.

### SUMMARY

In e.g. 3GPP Rel-17 ICBM based framework, the maximum number of reference signals (RSs) that can be configured for UE to measure for a single reporting configuration is up to 64 which includes RSs from both serving cell and up to 7 neighbouring cells. Since ICBM is limited to the intra DU scenario, the UE mobility is limited to a certain coverage area where both L1 measurement and reporting configuration update was not required very often. However, in case of LTM, the UE mobility is considered for both intra-DU and inter-DU which magnifies the mobility area beyond the intra-DU mobility. Considering that, further mechanisms may be needed to configure/update the UE with a specific set of reported SSBs, e.g., remove/or add RS indices. Continuous update of the CSI resource set by means of RRC Reconfiguration is costly in terms of signalling overhead and delay. Alternatively, multiple CSI reporting configurations, each configuring up to 64 RSs, to cover a large set of RSs for LTM may significantly incur measurement overhead at the UE. Also, Rel-17 ICBM based CSI measurement framework only works for intra-frequency scenarios.

Additionally, since in Rel-17 ICBM based CSI measurement framework, the whole L1 measurement and reporting configuration is given within the serving cell configuration, a cell change would require a complete reconfiguration of L1 measurement and reporting for the new serving cell which would incur significant UE processing cost in case of fast cell changes, i.e., every time when cell change occurs, the UE may need to read and process a large set of configuration associated with the new serving cell.

In a solution where Rel-17 ICBM based framework is not used, i.e., CSI-RSs of neighbouring cells are not configured within the serving cell configuration, instead, each cell has its own CSI-RSs only configured within its serving cell configuration. In such a scenario, reporting configuration of a serving cell cannot indicate the CSI-RSs not included in the serving cell configuration; therefore, measurements of neighbouring candidate target cells may not be enabled without enhancements.

Another potential option is replicating a Layer 3 (L3) like measurement framework, where the UE is not provided specific RSs and cells to be measured, may require a significant change to L1 measurement and reporting framework which would be significantly different from Rel-15/16/17 beam management, CSI framework. Also, in such a setting, reporting overhead may be significant since the UE has to include additional information (e.g., cell identifier) which is undesirable for L1 measurements since the L1 measurements are low layer messages (intended to be small in size) and reported more frequently then L3 measurements (leads significant signalling overhead in the air interface if the message size is increased).

A L1 measurement and reporting configuration is preferably to be designed which can advantageously satisfy at least one of the following LTM requirements, i.e., intra and inter-frequency measurements along with the intra-DU and inter-DU measurements from up to 8 cells, fast dynamic switching with minimal configuration change and without incurring any significant additional reporting overhead.

In accordance with an aspect of the present disclosure, there is provided a user equipment, UE, configured for supporting connection towards a radio access network including at least a first network node, wherein the UE comprises:
at least one processor; and
at least one memory storing instructions that, when executed by the at least one processor, cause the UE at least to:
send a measurement report comprising information indicative of at least one target cell of the at least one neighboring target cell to a first network node that supports at least one of central unit control plane, CU-CP, functionality and/or a layer 3 protocol of the radio access network,
receive, from the first network node, a configuration message comprising information indicative of a LTM measurement related configuration, wherein the LTM measurement related configuration comprises a resource related configuration for at least one of the serving cell the UE is connected to and one target cell the UE as candidate cell to perform a cell change to, and cell-specific LTM reporting related configuration,
perform measurements and report measurements related information based on at least part of the received LTM measurement related configuration.

In some examples the user equipment, UE, may be further configured to support: the resource related configuration includes a common or reference LTM-Meas Config related at least to the serving cell and one target cell.

In some examples the user equipment, UE, may be further configured to support: the resource related configuration includes an LTM-CSI Resource Set related at least to the serving cell and one target cell.

In some examples the user equipment, UE, may be further configured to support: the (cell specific) LTM reporting related configuration includes at least one of: LTM-Reporting Config, Measurement Gap, bitmap of activated LTM Config Indices and RSs for at least one of the serving cell and one target cell.

LTM-Reporting Config is e.g. related to the Uplink resource configuration of a cell. In general a CSI-Report Config contains several other parameters like e.g. an indicator for a CSI-Resource Config.

In some examples the user equipment, UE, may be further configured to support:
receive, from a second network node, a configuration message comprising information indicative of an updated LTM measurement related configuration, wherein the second network node supports at least one of distributed unit, DU, functionality and/or a layer 2 protocol of the radio access network.

In some examples the user equipment, UE, may be further configured to support::
determine resources for performing measurements based on the received updated configuration,
perform measurements, and
report measurements related information towards the second network node.

In some examples the user equipment, UE, may be further configured to support: the LTM reporting related configuration includes a default bitmap of activated LTM Config Indices and/or RSs for at least one of the serving cell and one target cell, and wherein the UE is further configured to:
receive, from a second network node, a configuration message comprising an updated bitmap of activated LTM Config Indices and RSs for at least one of the serving cell and one target cell, wherein the second network node supports at least one of distributed unit, DU, functionality and/or a layer 2 protocol of the radio access network.

In some examples the user equipment, UE, may be further configured to support: wherein the UE is further configured to:
report measurements related information towards a second network node, wherein the second network node supports at least one of distributed unit, DU, functionality and/or a layer 2 protocol of the radio access network,
receive, from the second network node, a cell switch command to perform a cell change to a target cell,
perform handover to the target cell,
determine cell-specific measurement parameters for the target cell based on the cell-specific LTM reporting related configuration,
perform measurements based on the received common LTM-Meas Config and the determined cell-specific, in particular LTM-Reporting Config parameters for e.g. the target cell,
report measurement related information towards a third network node supporting the target cell, wherein the third network node supports at least one of distributed unit, DU, functionality and/or a layer 2 protocol of the radio access network.

In some examples the user equipment, UE, may be further configured to support: the LTM measurement related configuration includes filter criteria for LTM meas for at least of serving cell and target cell.

In some examples the user equipment, UE, may be further configured to support: the LTM measurement related configuration includes a default sub-set of LTM cells for beam measurement for at least of serving cell and target cell.

In some examples the user equipment, UE, may be further configured to support:
determine resources, in particular LTM-CSI related, for performing measurements based on the received filter criteria.

In some examples the user equipment, UE, may be further configured to support:
receive, from a second network node, a configuration message comprising information indicative of an updated LTM measurement related configuration including updated filter criteria, wherein the second network node supports at least one of distributed unit, DU, functionality and/or a layer 2 protocol of the radio access network,
determine resources, in particular LTM-CSI related, for performing measurements based on the received updated filter criteria,
perform measurements, and
report measurements related information towards the second network node.

In some examples the user equipment, UE, may be further configured to support:
report measurements related information towards a second network node, wherein the second network node supports at least one of distributed unit, DU, functionality and/or a layer 2 protocol of the radio access network,
receive, from the second network node, a cell switch command to perform a cell change to a target cell,
perform handover to the target cell,
determine cell-specific measurement parameters for the target cell based on the cell-specific LTM reporting related configuration including filter criteria for the target cell,
perform measurements based on the determined cell-specific parameters,
report measurement related information towards a third network node supporting the target cell, wherein the third network node supports at least one of distributed unit, DU, functionality and/or a layer 2 protocol of the radio access network.

In accordance with an another aspect of the present disclosure, there is provided a user equipment, UE, configured for supporting connection towards a radio access network including at least a first network node, wherein the UE comprises:
at least one processor; and
at least one memory storing instructions that, when executed by the at least one processor, cause the UE at least to:
send a measurement report comprising information indicative of at least one target cell of the at least one neighboring target cell to a first network node that supports at least one of central unit control plane, CU-CP, functionality and/or a layer 3 protocol of the radio access network,
receive, from the first network node, a configuration message comprising information indicative of a LTM measurement related configuration,
receive, from a second network node, a configuration message comprising information indicative of an updated LTM measurement related configuration, wherein the second network node supports at least one of distributed unit, DU, functionality and/or a layer 2 protocol of the radio access network.

In some examples the user equipment, UE, may be further configured to support: the LTM measurement related configuration includes filter criteria for at least one of serving cell and target cell, and wherein the updated LTM measurement related configuration includes updated filter criteria for at least one of serving cell and target cell.

In some examples the user equipment, UE, may be further configured to support: the LTM measurement related configuration includes cell specific default bitmaps of activated LTM Config Indices for at least one of serving cell and target cell, and wherein the updated LTM measurement related configuration includes updated cell specific bitmaps of activated LTM Config Indices for at least one of serving cell and target cell.

In accordance with an another aspect of the present disclosure, there is provided a user equipment, UE, configured for supporting connection towards a radio access network including at least a first network node, wherein the UE comprises:
at least one processor; and
at least one memory storing instructions that, when executed by the at least one processor, cause the UE at least to:
send a measurement report comprising information indicative of at least one target cell of the at least one neighboring target cell to a first network node that supports at least one of central unit control plane, CU-CP, functionality and/or a layer 3 protocol of the radio access network,
receive, from the first network node, a configuration message comprising information indicative of a LTM measurement related configuration, wherein the LTM measurement related configuration comprises information to derive parameters for a cell specific measurement related the serving cell the UE is connected to and cell specific parameters related to one target cell,
determine parameters for a cell specific measurement related to the serving cell,
perform measurements based on the determined parameters,
report measurements related information towards a second network node supporting the serving cell, wherein the second network node supports at least one of distributed unit, DU, functionality and/or a layer 2 protocol of the radio access network.
receive, from the second network node, a cell switch command to perform handover to a target cell supported by a third network node, wherein the third network node supports at least one of distributed unit, DU, functionality and/or a layer 2 protocol of the radio access network,
perform handover to the target cell,
determine parameters for a cell specific measurement related to the target cell,
perform measurements based on the determined parameters, and
report measurements related information towards a third network node.

In accordance with an another aspect of the present disclosure, there is provided a method for a user equipment, UE, configured for supporting connection towards a radio access network including at least a first network node, the method comprising:
sending a measurement report comprising information indicative of at least one target cell of the at least one neighboring target cell to a first network node that supports at least one of central unit control plane, CU-CP, functionality and/or a layer 3 protocol of the radio access network,
receiving, from the first network node, a configuration message comprising information indicative of a LTM measurement related configuration, wherein the LTM measurement related configuration comprises a resource related configuration for at least one of the serving cell the UE is connected to and one target cell the UE as candidate cell to perform a cell change to, and cell-specific LTM reporting related configuration,
performing measurements and reporting measurements related information based on at least part of the received LTM measurement related configuration.

In accordance with an another aspect of the present disclosure, there is provided a method for a user equipment, UE, configured for supporting connection towards a radio access network including at least a first network node, the method comprising:
sending a measurement report comprising information indicative of at least one target cell of the at least one neighboring target cell to a first network node that supports at least one of central unit control plane, CU-CP, functionality and/or a layer 3 protocol of the radio access network,
receiving, from the first network node, a configuration message comprising information indicative of a LTM measurement related configuration,
receiving, from a second network node, a configuration message comprising information indicative of an updated LTM measurement related configuration, wherein the second network node supports at least one of distributed unit, DU, functionality and/or a layer 2 protocol of the radio access network.

In accordance with an another aspect of the present disclosure, there is provided a method for a user equipment, UE, configured for supporting connection towards a radio access network including at least a first network node, the method comprising:
sending a measurement report comprising information indicative of at least one target cell of the at least one neighboring target cell to a first network node that supports at least one of central unit control plane, CU-CP, functionality and/or a layer 3 protocol of the radio access network,
receiving, from the first network node, a configuration message comprising information indicative of a LTM measurement related configuration, wherein the LTM measurement related configuration comprises information to derive parameters for a cell specific measurement related to the serving cell the UE is connected to and cell specific parameters related to one target cell,
determining parameters for a cell specific measurement related to the serving cell,
performing measurements based on the determined parameters,
reporting measurements related information towards a second network node supporting the serving cell, wherein the second network node supports at least one of distributed unit, DU, functionality and/or a layer 2 protocol of the radio access network.
receiving, from the second network node, a cell switch command to perform handover to a target cell supported by a third network node, wherein the third network node supports at least one of distributed unit, DU, functionality and/or a layer 2 protocol of the radio access network,
performing handover to the target cell,
determining parameters for a cell specific measurement related to the target cell,
performing measurements based on the determined parameters, and
reporting measurements related information towards a third network node.

In accordance with an another aspect of the present disclosure, there is provided a computer program comprising instructions for causing an apparatus to perform any one of the above methods.

In accordance with an another aspect of the present disclosure, there is provided a memory storing computer readable instructions for causing an apparatus to perform any one of the above methods.

In accordance with an another aspect of the present disclosure, there is provided an apparatus comprising means for performing any one of the above methods.

In accordance with an another aspect of the present disclosure, there is provided a first network node configured to support at least one of central unit control plane, CU-CP, functionality and/or a layer 3 protocol of the radio access network for controlling a user equipment, UE, configured for supporting connection towards a radio access network including at least the first network node, wherein the first network node comprises:
at least one processor; and
at least one memory storing instructions that, when executed by the at least one processor, cause the first network node at least to:
receive, from the UE, a measurement report comprising information indicative of at least one target cell of the at least one neighboring target cell to,
send, towards the UE, a configuration message comprising information indicative of a LTM measurement related configuration, wherein the LTM measurement related configuration comprises a resource related configuration for at least one of the serving cell the UE is connected to and one target cell the UE as candidate cell to perform a cell change to, and cell-specific LTM reporting related configuration.

In accordance with an another aspect of the present disclosure, there is provided a first network node configured to support at least one of central unit control plane, CU-CP, functionality and/or a layer 3 protocol of the radio access network for controlling a user equipment, UE, configured for supporting connection towards a radio access network including at least the first network node, wherein the first network node comprises:
at least one processor; and
at least one memory storing instructions that, when executed by the at least one processor, cause the UE at least to:
receive, from the UE, a measurement report comprising information indicative of at least one target cell of the at least one neighboring target cell,
send, towards the UE, a configuration message comprising information indicative of a LTM measurement related configuration,
   send, towards a second network node, at least part of the LTM measurement related configuration to enable the second network node to generate and send, to the UE, a configuration message comprising information indicative of an updated LTM measurement related configuration, wherein the second network node supports at least one of distributed unit, DU, functionality and/or a layer 2 protocol of the radio access network.
   Part of the LTM measurement related configuration CU may send to the second network node a default bitmap of activated LTM Config, etc. This way the UE may already start measurements based on the default bitmap and activated cells, which may be updated by the second network node to e.g. adapt measurements for providing better or better suited measurements, e.g. to enable a better visibility for fast and sustainable cell changes.

In accordance with an another aspect of the present disclosure, there is provided a network node for a radio access network and for connecting a user equipment, UE, towards the radio access network, wherein the network node comprises a first network node and a second network node and:
at least one processor; and
at least one memory storing instructions that, when executed by the at least one processor, cause the UE at least to:
receive, in the first network node and from the UE, a measurement report comprising information indicative of at least one target cell of the at least one neighboring target cell, wherein the first network node supports at least one of central unit control plane, CU-CP, functionality and/or a layer 3 protocol of the radio access network,
send, towards the UE, a configuration message comprising information indicative of a LTM measurement related configuration, wherein the LTM measurement related configuration comprises information to derive parameters for a cell specific measurement related to the serving cell the UE is connected to and cell specific parameters related to one target cell,
receive, in the second network node and from the UE, a report including measurements related information towards a second network node supporting the serving cell, wherein the second network node supports at least one of distributed unit, DU, functionality and/or a layer 2 protocol of the radio access network,
send, towards the UE, a cell switch command to perform handover to a target cell supported by a third network node, wherein the third network node supports at least one of distributed unit, DU, functionality and/or a layer 2 protocol of the radio access network.

In accordance with an another aspect of the present disclosure, there is provided a second network node configured to support at least one of distributed unit, DU, functionality and/or a layer 2 protocol of a radio access network, and configured to connect to a first network node supporting at least one of central unit control plane, CU-CP, functionality and/or a layer 3 protocol of the radio access network for controlling a user equipment, UE, configured for supporting connection towards the radio access network including at least the first network node and the second network node, wherein the second network node comprises:
at least one processor; and
at least one memory storing instructions that, when executed by the at least one processor, cause the UE at least to:
receive, from the first network node, at least part of LTM measurement related configuration provided to the UE, to enable the second network node to generate and send, to the UE, a configuration message comprising information indicative of an updated LTM measurement related configuration, and
receive, from the UE, a measurement report based on at least part of the LTM measurement related configuration.

The First network node may e.g. be implemented as a network node that supports distributed unit, DU, functionality and/or a layer 2 protocol processing of a radio access network, RAN, a source DU, a serving DU, a serving gNB, a 5G gNB, a NR gNB, and/or a base station, which offers a broad applicability to different RAN implementation.

The Second network node may e.g. be implemented as a network node that supports distributed unit, DU, functionality and/or a layer 2 protocol processing of a radio access network, RAN, a target DU, a target gNB, a 5G gNB, a NR gNB, and/or a base station, which again offers broad applicability to different RAN implementations. The first and the second network node could be the same of different nodes.

A Third network node may e.g. be implemented as a network node that supports central unit, CU, functionality and/or a layer 3 protocol processing of a radio access network, RAN, a CU, a source CU, a serving CU, a source gNB, a 5G gNB, a NR gNB, and/or a base station. The Third network node may control the first network node and/or the second network node. The first and the second network node may be controlled by the same node or by different nodes.

The User equipment may e.g. be implemented as an apparatus or equipment that supports layer 2 and layer 3 protocol processing of a radio access network, RAN, a smartphone, and/or a mobile terminal.

The Measurement report may e.g. be implemented as or based on Layer 1 (L1) measurement report, Layer 3 (L3) measurement report.

The configuration information related to performing measurements for a target cell as candidate cell for a cell change, wherein the target cell is supported by a second network node (target DU) may be received via an RRC Reconfiguration message and/or Layer 3 (L3) message. The message may be received from a network node supporting L3, e.g. supporting central unit (CU) functionality, this may depend on the implementation. The message may be received from the first network node in case it supports L3 as well. The message is e.g. used to configure the UE with L1 measurement usable for a Lower Layer Mobility (LLM) or LTM triggered cell change.

The order of the indicated processing steps is not necessarily a sequential order. Measurement reports can be send e.g. on a periodic or aperiodic (e.g. event based) basis.

According to some example embodiments, there is also provided a computer program comprising instructions for causing an apparatus to perform a method as disclosed in the present disclosure.

According to some example embodiments, there is also provided a memory storing computer readable instructions for causing an apparatus to perform a method as disclosed in the present disclosure.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses according to the above example embodiments and variations thereof, and that respective statements made with regard to the apparatuses likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Based on the above a first solution is proposed, e.g. a L1 measurement and reporting configuration for LTM which advantageously can satisfy at least one of the key LTM requirements, i.e., intra and inter-frequency measurements along with the intra-DU and inter-DU measurements from up to N cells (N=1, 2, 3, 4, 5, . . . , e.g. N=8), fast dynamic switching with minimal configuration change and without incurring any significant additional reporting overhead. One potential approach can be the following.

In the preparation phase, the UE is provided with a common set of CSI resources consolidated over a set of candidate cells which may be specific for LTM (e.g., LTM-CSI-Resource-set), and it is maintained as a part of the common RRC configuration retained across LTM cell switching (over multiple LTM neighbouring cells). This set may contain detail parameters for each RS in terms of its timing, frequency, and power configuration. The resources from different cells may be differentiated by an identifier (PCI or a shorter local index to save some bit, e.g., LTM-Config-Index, which may also be reused later in the cell switch command to provide target cell identifier).

For each cell (serving and candidate cells), a cell specific configuration (e.g., delta configuration compared to the common RRC configuration) may contain reporting configuration in terms of uplink resources to be used for reporting, measurement gap configuration to enable inter-frequency measurements, and an initial or default set of activated RSs (e.g., a bitmap of LTM-Config-Indices) from the common LTM-CSI-Resource-set to consider for measurements

The initial set of activated RSs may dynamically be changed later (e.g., via a MAC-CE from the serving cell) based on the UE mobility; however, there is no change required to the LTM-CSI-Resource-set, and the reporting configuration.

With the above approach, even when a cell switch occurs, the UE may or is enabled to keep using the same common set of RSs (LTM-CSI-Resource-set), but switches to new serving cell's cell-specific configuration in terms of reporting, and measurement gap configuration and measurement RSs from the LTM-CSI-Resource-set based on the default activated set of RSs. This approach would require minimal RRC configuration processing at the UE side when cell switches occur, and at the same time enables dynamic activation/deactivation of appropriate set measurements RSs from candidate cells for LTM L1 measurements. Note that if needed, the CU may always change the common set of RSs (LTM-CSI-Resource-set) via RRC reconfiguration when for example, a new cell needs to be added or removed, but that is not expected to be done too frequently.

It is proposed: For LTM L1 measurement configuration, a common set of RSs across neighbouring cells specific for LTM measurements is provided, where
detail parameters for each RS in terms of its timing, frequency, and power configuration are given, and/or
the resources from different cells may be differentiated by an identifier (LTM-Config-Index, e.g. which may also be reused later in the cell switch command to provide target cell identifier), and/or
this configuration may be retained across LTM cell switching; however, may be updated by the CU if needed (e.g., adding/removing a cell/RS).

Further, for LTM L1 measurement configuration, along with a common set of measurement RSs, a cell specific RRC configuration is provided, which e.g. includes:
reporting configuration providing the uplink resource configuration for reporting the measurements, and/or
measurement gap configuration for inter-frequency measurements, and/or
a set of activated RSs/cells (e.g., a bitmap of LTM-Config-Indices) from the common LTM-CSI-Resource-set to consider for measurements.

A set of activated RSs (e.g., a bitmap of LTM-Config-Indices) from the common LTM-CSI-Resource-se can dynamically be changed later (e.g., via a MAC-CE from the serving cell).

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 is a block diagram of one possible and non-limiting system in which the example embodiments may be practiced;

FIG. 2 schematically illustrates an example of LTM cases in rel-18 with inter-CU, intra-CU and inter-DU cell switches;

FIG. 3 schematically illustrates an example of Common and Cell Sepecific L1 measurement and reporting configuration for L1/2 triggered mobility (LTM);

FIG. 4 schematically illustrates an example of a first embodiment;

FIG. 5 schematically illustrates an example of a second embodiment;

FIG. 6 schematically illustrates an example apparatus configured to implement at least one example described herein;

FIG. 7 schematically illustrates an example of a method to implement at least one example described herein;

FIG. 8 schematically illustrates an example of a method to implement at least one example described herein.

### DESCRIPTION OF EXAMPLE EMBODIMENTS

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele)communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g., according to 3GPP TS 38.401 V16.6.0 (2021-07) section 3.1 incorporated by reference.

Different functional splits between the central and distributed unit are possible, e.g., called options:
Option 1 (1A-like split):
   The function split in this option is similar to the 1A architecture in DC. RRC is in the central unit. PDCP, RLC, MAC, physical layer and RF are in the distributed unit.
Option 2 (3C-like split):
   The function split in this option is similar to the 3C architecture in DC. RRC and PDCP are in the central unit. RLC, MAC, physical layer and RF are in the distributed unit.
Option 3 (intra RLC split):
   Low RLC (partial function of RLC), MAC, physical layer and RF are in the distributed unit. PDCP and high RLC (the other partial function of RLC) are in the central unit.
Option 4 (RLC-MAC split):
   MAC, physical layer and RF are in the distributed unit. PDCP and RLC are in the central unit.
Or else, e.g., according to 3GPP TR 38.801 V14.0.0 (2017-03) section 11 incorporated by reference.

A gNB supports different protocol layers, e.g., Layer 1 (L1)—physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

3GPP RAN groups are discussing about L1L2-Triggered Mobility (LTM). Namely to specify mechanism and procedures of L1/L2 based inter-cell mobility for mobility latency reduction: Configuration and maintenance for multiple candidate cells to allow fast application of configurations for candidate cells [RAN2, RAN3]; Dynamic switch mechanism among candidate serving cells (including SpCell and SCell) for the potential applicable scenarios based on L1/L2 signalling [RAN2, RAN1]; L1 enhancements for inter-cell beam management, including L1 measurement and reporting, and beam indication [RAN1, RAN2](Note 1: Early RAN2 involvement is necessary, including the possibility of further clarifying the interaction between this bullet with the previous bullet); Timing Advance management [RAN1, RAN2]; and CU-DU interface signaling to support L1/L2 mobility, if needed [RAN3]. Note 2: FR2 specific enhancements are not precluded, if any. Note 3: The procedure of L1/L2 based inter-cell mobility are applicable to the following scenarios: Standalone, CA and NR-DC case with serving cell change within one CG; Intra-DU case and intra-CU inter-DU case (applicable for Standalone and CA: no new RAN interfaces are expected); Both intra-frequency and inter-frequency; Both FR1 and FR2. Source and target cells may be synchronized or non-synchronized.

The main goal of this work is to reduce the handover latency in the scenarios described above.

In general, for L1L2 Triggered Mobility (LTM) it is expected that the UE reports L1 beam measurements to the serving DU and as such the serving DU can decide when to trigger the handover. The purpose of this is to simplify many of the network and UE mobility procedures as well as reduce the interruption time/delay caused by the mobility. Furthermore, network data forwarding, scheduling are expected to also benefit from LTM. In the LTM, UE may maintain configuration of multiple cells to apply the fast application of each configuration.

The LTM may involve serving cell change or not, and it can use either RACH or be RACH-less.

In LTM, the serving DU triggers the execution of the prepared target cell configuration based on lower layer signaling, which can be either MAC Control Element (MAC CE) or Downlink Control Information (DCI). Upon triggering the cell change, the serving DU informs the CU such that the CU can stop sending any RRC Reconfiguration over the serving cell radio link and initiate data forwarding to the target cell, if needed.

LTM is expected to use L1 measurements. These measurements have the benefit of faster reaction time to radio link degradation in the serving link as the network can save the delay introduced by L3 filtering and Time to Trigger (TTT) for the handover decision. This should result in reducing in the number of radio link failures compared to baseline handover.

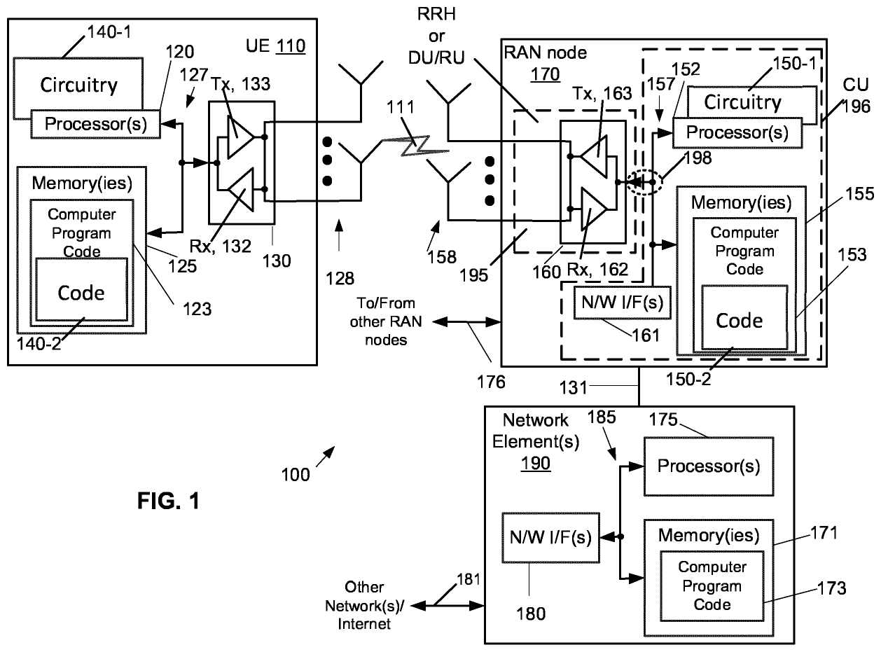

Turning to FIG. 1, this figure shows a block diagram of one possible and non-limiting example of an illustration of a wireless network 100 in which the examples may be practiced. A user equipment (UE) 110, a radio access network (RAN) node 170, and a network element(s) 190 are illustrated. In the example of FIG. 1, the user equipment (UE) 110 is in wireless communication with RAN node 170. A UE is a device with a radio interface to access the wireless network 100. The UE 110 includes e.g. one or more processors 120, one or more memories 125 (with computer program code stored thereon), and one or more transceivers 130 interconnected through one or more buses 127 or other wired connections. At least one of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. At least one of the one or more transceivers 130 is connected to at least one or more antennas 128. At least one of the one or more memories 125 includes computer program code 123. The UE 110 includes circuitry 140-1 and/or code 140-2, which may be implemented in a number of ways. The circuitry 140-1 may be implemented in hardware, such as being implemented as part of the one or more processors 120. The circuitry 140-1 may be implemented also as an integrated circuit or through other hardware such as a programmable gate array. In another example, code 140-2, may be implemented as computer program code 123 and is executable by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless or radio link 111. Circuitry 140-1 and/or code 140-2 may provide L2 and/or L3 functionality, e.g. L2 and/or L3 control plane signal processing.

The RAN node 170 in this example is a base station that provides access to the UE 110. The RAN node 170 may be, for example, a base station for 5G, also called New Radio (NR). In 5G, the RAN node 170 may be a NG-RAN node, e.g. a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs. A gNB may include a central unit (CU) (gNB-CU) 196 and one or more distributed unit(s) (DUs) (gNB-DUs), of which DU 195 is shown. Note that the DU 195 may include or be coupled to and control a radio unit (RU). The gNB-CU 196 is a logical node which may host radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node which may host RLC, MAC and PHY layers of the gNB or en-gNB, and its operation is partly controlled by gNB-CU 196. One gNB-DU 195 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the gNB-DU 195 may include at least one processor and at least one memory with computer program code stored thereon, and the transceiver 160, e.g., as part of a Radio Unit (RU), but some examples of this may have the transceiver 160 as part of a separate RU, e.g., under control of and connected to the gNB-DU 195. The one or more transceivers 160 are connected to one or more antennas 158. The gNB-DU 195 may further include circuitry and/or code which may provide L2 functionality, e.g. L2 control plane signal processing. The RAN node 170 may also be an eNB (evolved NodeB) base station, for LTE (long term evolution), or any other suitable base station or node.

The gNB-CU 196 (and/or RAN node 170) may include one or more processors 152, one or more memories 155, one or more network interfaces (N/W I/F(s)) 161, interconnected through one or more buses 157 or other wired connections. At least one of the one or more memories 155 includes computer program code 153, e.g. computer-readable instructions. The DU 195 may also contain its own memory/memories and processor(s), and/or other hardware.

The RAN node 170 (and/or CU 196 and/or DU 195) includes circuitry 150-1 and/or code 150-2, which may be implemented in a number of ways. The circuitry 150-1 may be implemented in hardware, such as being implemented as part of the one or more processors 152. The circuitry 150-1 may be implemented also as an integrated circuit or through other hardware such as a programmable gate array. In another example, code 150-2, may be implemented as computer program code 153 and is executable by the one or more processors 152. For instance, the one or more memories 155 and the computer program code 153 may be configured to, with the one or more processors 152, cause the gNB-CU 196 (and/or RAN node 170 and/or DU 195) to perform one or more of the operations as described herein. Circuitry 150-1 and/or code 150-2 may provide L3 functionality, e.g. L3 control plane signal processing.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions.

Accordingly, UE 110, RAN node 170, and/or network element(s) 190, (and associated memories, computer program code and modules) may be configured to implement (e.g. in part) the examples described herein, including enabling using per-target-cell CU-UP in CPA/CPC initiation. Thus, computer program code 123, circuitry 140-1, code 140-2, and other elements/features shown in FIG. 1 of UE 110 may be configured to implement user equipment related aspects of the examples described herein. Similarly, computer program code 153, circuitry 150-1, code 150-2, and other elements/features shown in FIG. 1 of RAN node 170, including the CU 196 and DU 195, may be configured to implement RAN/gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

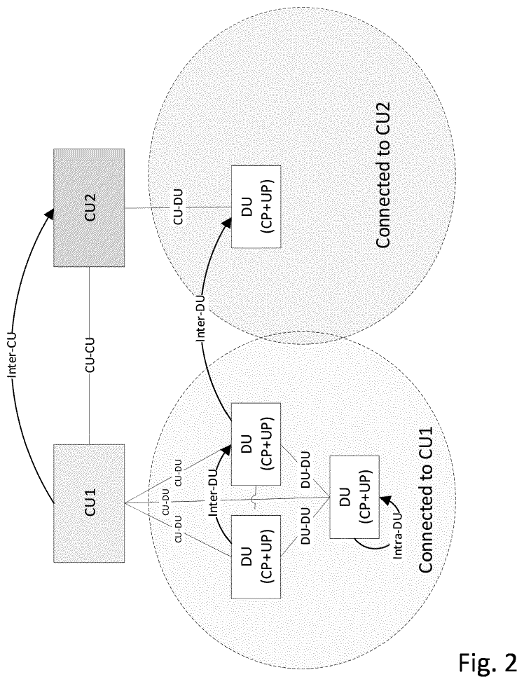

To illustrate different LTM scenarios, FIG. 2 shows the difference between inter-CU (L3 Handover) and intra-CU, inter-DU cell switches. The release-18 work focuses initially on intra- and inter-DU cases. The scope can be extended further in the future releases.

According to for instance NR38.133, V17.6.0, “Technical Specification Group Radio Access Network; NR; Requirements for support of radio resource management”, section 9.13.2, the known condition of a cell in 3GPP is defined as follows, namely that the cell with different Physical Cell ID (PCI) from serving cell is considered as known if the following conditions are met in this requirement:
The SSB of the cell with different PCI from serving cell has the same SCS and center frequency as the SSB of the PCell;
The timing difference of arrival at UE between the SSBs of serving cell and cell with different PCI is less than CP length of the corresponding SCS;
The UE has sent a valid L3 measurement report during the last 5 seconds; and
The SSB from the cell with different PCI remains detectable according to the cell identification requirements specified in clause 9.2.
Otherwise, the cell is unknown.

The above conditions are defined from UE perspective and with reference to Synchronization Signal/PBCH Block (SSB).

The first condition states that “The SSB of the cell with different PCI from serving cell has the same SCS and center frequency as the SSB of the PCell”. This is the definition that RAN4 has agreed in the last meeting for intra-frequency measurement. From the tdoc reviews from the current meeting, there is a trend that inter-frequency measurements are considered in LTM. As a result, the above known condition would have to be revised for LTM case.

The second condition states that “The timing difference of arrival at UE between the SSBs of serving cell and cell with different PCI is less than CP length of the corresponding SCS”. This is the definition for synchronised or asynchronized transmission. It is also being discussed if this concept shall be adopted in the case of LTM.

The last two criteria are not definition related, and straight forward as measurements report or values are obvious to see. Hence, these two criteria are discussed in the present disclosure.

The detectability of the SSB as defined in NR 38.133, Clause 9.2/9.3 is that “The UE shall be able to identify new intra inter-frequency cells and perform SS-RSRP, SS-RSRQ, and SS-SINR measurements of identified intra inter-frequency cells if carrier frequency information is provided by PCell or the PSCell, even if no explicit neighbour list with physical layer cell identities is provided.”

An intra/inter-frequency cell shall be considered detectable when for each relevant SSB:
SS-RSRP related side conditions given in NR38.133, clauses 10.1.4 and 10.1.5 for FR1 and FR2, respectively, for a corresponding Band,
SS-RSRQ related side conditions given in NR38.133, clauses 10.1.9 and 10.1.10 for FR1 and FR2, respectively, for a corresponding Band,
SS-SINR related side conditions given in NR38.133, clauses 10.1.14 and 10.1.15 for FR1 and FR2, respectively, for a corresponding Band,
SSB_RP and SSB Ês/Iot according to NR38.133, Annex B.2.3 for a corresponding Band.

As explained above, the candidate cell RRC configurations are prepared by the CU based on L3 measurements. UE does the L1 measurements for the candidate cells, and DU triggered the serving cell change based on those L1 measurements.

According to some example embodiments, there are also provided corresponding methods suitable to be carried out by the apparatuses (network elements/components) as described above, such as the UE, the CU, the DU, etc.

L1/L2 triggered mobility (LTM)

LTM denoted also as L1/2 inter-cell mobility, is one of the objectives for mobility enhancement in Rel. 18. According to the paradigm description, the decision about the cell change is based on L1 measurements and is made in the MAC layer in the Distributed Unit (DU).

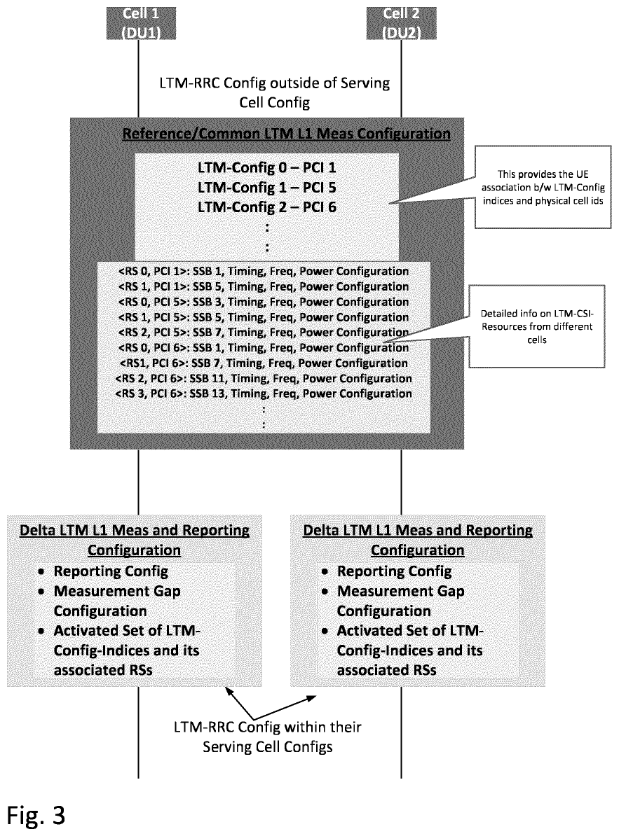

FIG. 3 shows one exemplary Common and Cell Sepecific L1 measurement and reporting configuration for L1/2 triggered mobility (LTM), e.g. useable for solution 1 below. In brief:

For a cell 1 supported by DU1 and a cell 2 supported by DU2 reference or common LTM L1 Meas Configuration is generated. Cell 1 is e.g. the serving cell the UE is connected to, cell 2 is e.g. a target cell the UE potentially performs handover to. The reference configuration includes multiple parameters, e.g. related to physical cell ids, CSI-resources, e.g. related to timing, frequency, power configuration per cell, etc.

For a cell 1 supported by DU1 a first cell-specific delta LTM L1 Meas and Reporting Configuration is generated. The reporting configuration includes multiple parameters, e.g. related to reporting, measurement gaps, activated set of LTM Config Indices and its associated RSs.

For a cell 2 supported by DU2 a second cell-specific delta LTM L1 Meas and Reporting Configuration is generated. The reporting configuration includes multiple parameters, e.g. related to reporting, measurement gaps, activated set of LTM Config Indices and its associated RSs.

LTM-Reporting Config is e.g. related to the Uplink resource configuration of a cell. In general a CSI-Report Config contains several other parameters like e.g. an indicator for a CSI-Resource Config.

In particular, a new L1 measurement resource configuration, e.g. for LTM beam based switching is proposed, which may also be used for beam-switching without configuration changes similar to ICBM among subset of LTM cells (e.g., candidate target cells). In particular two exemplary solutions are proposed for building the L1 measurement resource configuration for LTM measurements. These solutions are described below.

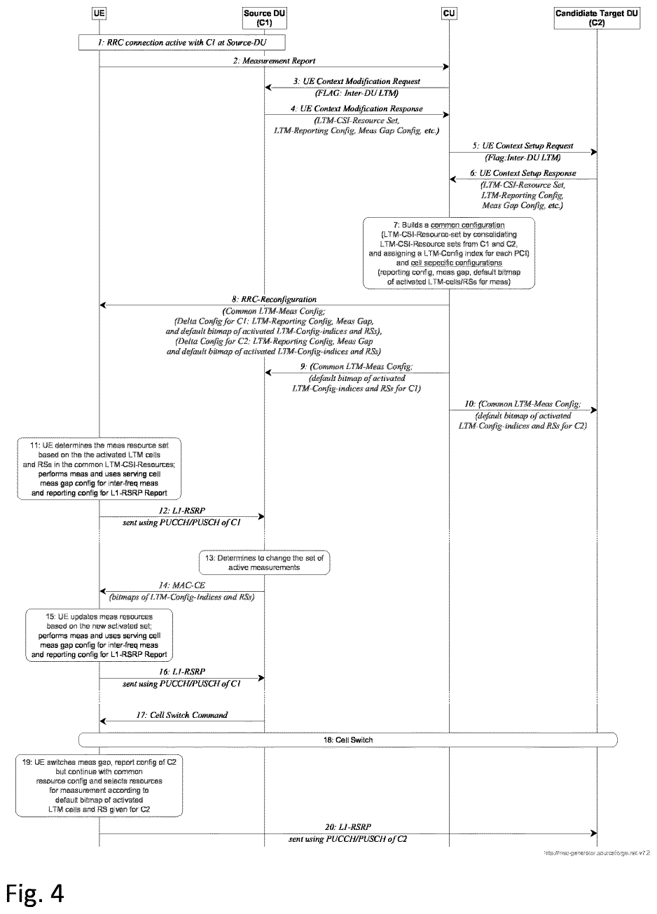

First a Solution 1 is described in detail, followed by an exemplary implementation as illustrated in FIG. 4: Network configuration of selected CSI-Resources (e.g., SSBs or/and CSI-RSs) of LTM candidate cells as new LTM-CSI-Resource-set for LTM Layer 1 (L1) or beam measurements that is maintained as common configuration retained across LTM cell-switching.

### Preparation Phase

As part of LTM preparation, CU request candidate target cell(s) and the serving cell to provide selected subset of CSI Resources (e.g., SSBs or/and CSI-RSs) for LTM L1/beam measurement. In response, a cell provides the following LTM measurement and reporting related parameters:

LTM-CSI-Resource set (i.e., a set of SSBs/CSI-RSs selected for LTM).

The detail configuration of each RS (SSB/CSI-RS), e.g., timing configuration (timing occasions), frequency configuration (ARFCN, frequency band, sub-carrier/PRB location, etc.), power related parameters (average power, power offset, etc.).

In one example, Rel-17 SSB-MTC-AdditionalPCI information element type configuration may be used for SSB configuration for each cell with additional configuration parameters to provide the frequency configuration information.

LTM-Reporting-configuration, containing the uplink resources (e.g., periodic) allocated for reporting for LTM, which can be used to report the LTM L1 measurements which may be different from regular CSI-Report configuration.

A measurement gap configuration for the UE to perform inter-frequency measurements for LTM.

CU builds a reference/common configuration for LTM related measurements by consolidating the LTM-CSI-Resource sets received from all target cells as single LTM-CSI-Resource-set towards UE.

The resources of different target cells are differentiated by LTM-Config-Index. There may be one LTM-Config-Index provided to each cell, and the CSI-Resource set of a cell may directly be referred by its LTM-Config-Index. In another example, the LTM-Config-Index of a cell may be provided along with each SSB/CSI-RS. The mapping between LTM-Config-Index and physical cell id (PCI) of a cell may also be provided in the common LTM measurement configuration.

The common configuration may also contain the detailed configuration parameters for each RS, e.g., in terms of its timing, frequency, power configuration.

In addition to common LTM measurement configuration, the CU forms the following configuration for each cell (serving and candidate target cells) as part of the cell specific/delta configuration (e.g., delta LTM measurement and reporting configuration compared to the common LTM measurement configuration)
a set of LTM-Config indices (e.g., an initial or default bitmap of LTM-Config indices) in the RRC message to activate measurements for only subset of LTM cells (CSI-Resources) from the common LTM-CSI-Resource set

In one example, an initial or default bitmap may be determined based on the L3 measurements.

In another example, an initial or default bitmap may contain resources from the current serving cell or current and previous serving cell or no activated RS measurements.

In one solution, for each LTM-Config-Index (LTM cell) selected for beam measurement, further, an initial or default list containing a sub-set of RSs associated with that LTM cell to be used for beam measurements may also be given to the UE. In an example, a bit map of selected RSs may also be included for each activated LTM-Config-Index in the RRC message.

In another example, if no information is provided for the RSs for a LTM cells, the all the RSs may be considered as active for that cell.
reporting configuration (e.g., uplink resources to be used for reporting)
measurement gap configuration (for inter-frequency measurements).

CU provides both common configuration and cell specific/delta configurations for LTM measurements and reporting to the UE

Common configuration details are also shared with all the LTM cells; this is to enable the cell to interpret the UE LTM reporting. As described below, the UE reporting may just indicate the resource identifier and the corresponding measurement, the actual PCI and SSB/CSI-RS index corresponding to the reported resource ID may be derived based on the details in the common configuration.

Each cell's specific configuration (mainly the initial/default set (e.g., bitmap) of activated of LTM cells and RSs selected by the CU for that cell) is also shared with that cell itself

UE receives the LTM configurations, a common LTM-CSI-Resource-configuration and cell specific configuration including LTM-L1-Report-Configuration, a (default/initial) bitmap of activated LTM-Config-Indices/RSs and measurement gap configuration for inter-frequency measurements. UE starts LTM beam measurements based on the measurement configuration and the bitmap which indicate the subset of resources which needs to be measured and reported. For measurements, UE obtains the PCI, timing, frequency, power related configuration of the reference signal to be measured from the common configuration received.

The UE may use measurement gaps if inter-frequency measurements need to be performed as per the configured activated set.

### Measurement Phase

UE reports the L1-RSRP measurements based on the measurements over selected resources indicated by RRC. UE uses the uplink resources configured in the LTM-L1-Report Configuration to send the reports. UE may be configured to report only M best measurements in a single instance of the report (M=1, 2, 3, . . . , e.g. M=4). A resource index may be included with each L1-RSRP measurement. Resources indices may be defined only over the activated CSI-resources, e.g., in the increasing order of CSI-RS indices for each activated LTM cell, starting from the lowest LTM-Config-Index. For example, if the activated resources are [{SSB 5, LTM-Config-Index 0}, {SSB 9, LTM-Config-Index 0}, {SSB 1, LTM-Config-Index 1}, {SSB 2, LTM-Config-Index 2}, {SSB 5, LTM-Config-Index 2}, {SSB 10, LTM-Config-Index 3}], then the following resources indices may be used in the reporting:

| | Resource Index |
|---|---|
| Resource | in the report |
| {SSB 5, LTM-Config-Index 0} | 0 |
| {SSB 9, LTM-Config-Index 0} | 1 |
| {SSB 1, LTM-Config-Index 1} | 2 |
| {SSB 2, LTM-Config-Index 2} | 3 |
| {SSB 5, LTM-Config-Index 2} | 4 |
| {SSB 10, LTM-Config-Index 3} | 5 |

DU may decide to switch the LTM-cell along with beam index. Here DU should ensure that the latest measured beam within specific time is used to avoid UE re-acquiring the beam during switching.

In one example, LTM command for cell switching may include Resource Index from activated set of resources in the common configuration. The resource index would implicitly indicate the LTM cell (as the target cell indication) and the associated RS (as the QCL reference indication) to be used for cell switching.

In another example, a set of resources associated with a cell in the common configuration may be assigned a local index within that cell (starting from zero to the N−1, where N is the total number of RSs of that cell in the common configuration). The LTM command for cell switching may include the LTM-config-index and the local RS index which would implicitly indicate the LTM cell and the associated RS to be used for cell switching.

Based on L1 measurements or L3 measurements DU may decide to modify the list of LTM cells for beam measurements. In this case DU sends a command (MAC command, e.g., MAC-CE or a DCI) containing the bitmap of LTM-Indices. In an example, the DU/CU may also provide a bitmap of sub-set of CSI-RSs to be used for beam measurements for each activated LTM cell.

In another example, the serving CU may also update the list of LTM cells for beam measurements and send it to the UE (via serving DU) and the serving DU.

### Execution Phase

When the cell switch happens, the common configuration of LTM measurements may not need to be changed. After the cell switch, the UE will start using the new serving cell's reporting, measurement gap configuration for L1 measurement reporting for the LTM. The UE will perform measurements on the RSs activated for the new serving cell (e.g., given in the initial/default bitmap of activated LTM cells or/and RSs for measurements by the CU) which may be updated later by the serving DU/CU. Wherein the default/initial activated set of LTM cells may comprise at least one of: the current serving cell or the current serving cell and the previous serving cell or no active configurations or the configuration indicated in the cell switch command.

In another example, the UE may be configured/indicated to use the latest bitmap of activated LTM-cells and/or RSs given to the UE before the cell switch (by the previous serving cell). In such scenario, the serving cell before the cell switch may share the latest bitmap of activated LTM-cells and/or RSs with the target cell before/during the cell switch.

Alternative method for solution 1:

Instead of providing a bitmap of activated CSI-RS Resources of LTM cells from the common LTM-CSI-Resource-set, multiple reporting configurations, each associated with a different set of RSs from the common LTM-CSI-Resource-set (a set may contain resources from one or more LTM cells) may be configured for each cell. Reporting configurations may be part of the cell specific/delta configuration. In this option, the UE measurements can be controlled based on bitmap of CSI-Report-Config-Indices from DU. UE will measure and report the configurations activated via DU.

FIG. 4 schematically illustrates an example of a first embodiment.

A UE is connected to a cell C1 supported by a distributed unit Source DU, and sends a Layer 3 measurement report to the central unit CU connected to and controlling the distributed unit Source DU. The central unit CU prepares LTM config for a detected taget cell C2 supported by distributed unit Candidate Target DU. It therefore sends a UE Context Modification Request to the Source DU to request relevant data, e.g. LTM-CSI-Resource Set, LTM Reporting Config, Meas Gap Config, etc. CU may receive from source DU, at lest one of LTM CSI resource related configuration, LTM reporting config, Meas Gap Config which enables the CU to form LTM-Meas Config and cell specific configs. The CU further sends a UE Context Setup Request to the Candidate Target DU to request relevant data, e.g. LTM-CSI-Resource Set, LTM Reporting Config, Meas Gap Config, etc. Once the requested data is received the CU generates a corresponding LTM measurement related configuration, including e.g. a common or reference configuration and a cell-specific configuration. The CU forwards the LTM measurement configuration or parts thereof or part of the generated data to the UE, the Source DU and the Candidate Target DU. The UE is thus enabled to determine relevant measurement parameters to perform LTM related measurements and report them to Source DU. Source DU is enabled to update at least some parameters and send the updated parameters to the UE. UE is then enabled to use the updated parameters to perform adapted measurements. When Source DU sends a cell change/cell switch command to UE to perform handover to target cell C2, UE switches meas gap and report config to C2. This way UE is enabled to send adapted measurement results directly after cell switch to target cell C2 (new serving cell), e.g. without the need of a preconfiguring by target cell C2. Target cell C2 can however update at least one parameter, e.g. bitmaps of LTM Config Indices and RSs after cell switch to enabled even better measurements.

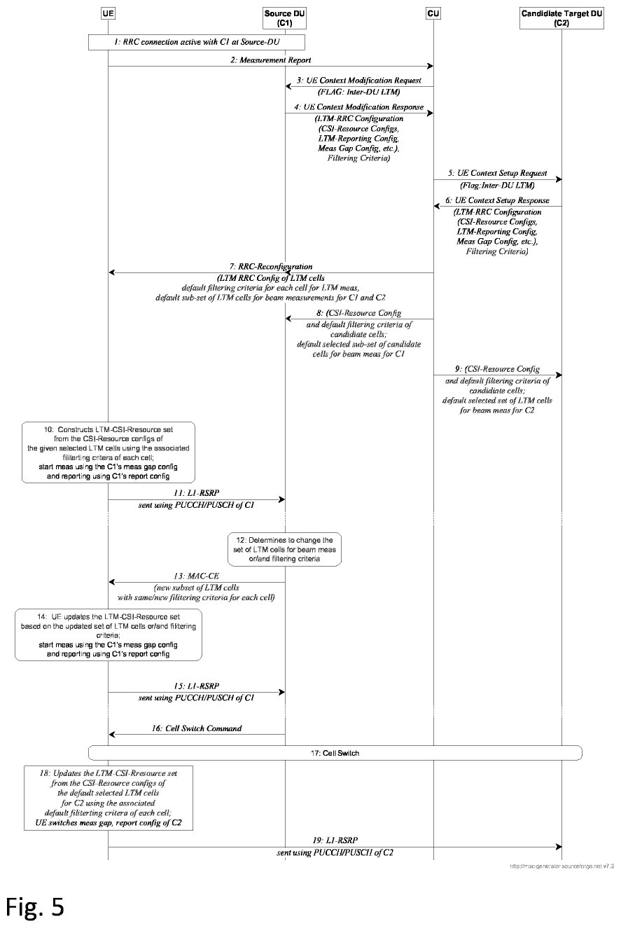

First a Solution 2 is described in detail, followed by an exemplary implementation as illustrated in FIG. 5: UE based solution for building of CSI-RS-Resource for LTM beam measurements with NW assistance for partial decoding of target configurations

### Preparation Phase:

A candidate target DU in response to preparation for LTM does not provide separate CSI-RS resources to CU. Instead, it provides ‘filtering’ criteria (e.g., default filiterting criteria) to obtain specific configuration for LTM from the candidate target DU's LTM-RRC-Configuration. For example, the ‘filter’ may be CSI-RS-Resource config with SSB as reference signal and/or a frequency configuration (e.g., ARFCN, frequency band and/or BWP-ID), and/or timing configuration (e.g., periodicity, and/or slot/sub-frame/frame numbers, etc.) set to a specific value. Another example of a filter criterion may be CSI-RS resources with a specific SSB(s) as Quasi-Co-Location (QCL) source(s).

CU sends only the LTM RRC configurations of LTM candidate cells towards UE to start LTM measurements. For every LTM configuration there will be additional filtering criteria or pointers provided to partial decoding of configuration to obtain the beam measurement part.

CU may also provide subset of LTM cells for beam measurement in this message as similar to Solution 1.

A default sub-set of LTM cells for beam measurements may be provided for each candidate cell within their cell specific configuration which the UE may use initially upon cell switch to that cell.

In an example, a default sub-set may contain resources from the current serving cell or current and previous serving cell or no activated cell.

CU shares with each LTM cell, CSI-Resource Configs and filterring criteria (e.g., default filtering criteria) of its candidate cells and a default selected sub-set of candidate cells for beam measurements

On receiving LTM RRC configurations along with ‘filter’ configuration and subset of LTM-cells for beam measurements, UE partially decode the LTM configurations of given subset of LTM-cells and construct LTM-CSI-Resource set and start measurements based on the same.

### Measurement Phase:

The UE steps during the measurement phase remain same as solution 1. It is possible to control the subset of LTM-cells for beam measurements and/or the filter (e.g., type of resources and BWP-ID of measurement resources) for one or more selected LTM-cells via MAC or layer 1 (DCI) command from DU. The UE can apply this new criteria to filter out the reference signals and form new LTM measurement set.

In another example, CU may also update the subset of LTM-cells for beam measurements and/or the filter (e.g., type of resources and BWP-ID of measurement resources) for one or more selected LTM-cells and send it to the UE (via serving DU) and the serving DU.

### Execution Phase:

Upon cell switch, UE may determine LTM-CSI-Resource set for the new serving cell by using the considering the default sub-set of LTM cells for beam measurements given for the new serving cell using the given default filiterting criteria associated each LTM cell.

### Summary of Key Methods

### Solution 1:

New LTM-CSI-Resource set configuration is configured at UE based on NW selecting subset of CSI-Resources applicable for LTM switching.

The subset of CSI resources to be measured and reported can be controlled by LTM-cell-index bitmap via RRC and MAC.

### Solution 2:

Method for UE to construct the LTM-CSI-Resource-configuration from the RRC-Configurations of LTM candidate cells based on network provisioned ‘filter’ criteria.

MAC based command to modify the Resource-type and BWP information of LTM-CSI-Resource-configuration which is used by UE to reconstruct the LTM-CSI Resource set based on these as new ‘filter’ criteria.

FIG. 5 schematically illustrates an example of a second embodiment.

A UE is connected to a cell C1 supported by a distributed unit Source DU, and sends a Layer 3 measurement report to the central unit CU connected to and controlling the distributed unit Source DU. The central unit CU prepares LTM config for a detected taget cell C2 supported by distributed unit Candidate Target DU. It therefore sends a UE Context Setup or Modification Request to the Source DU to request relevant data, e.g. LTM-CSI-Resource Set, LTM Reporting Config, Meas Gap Config, etc., and filtering criteria for determining relevant data. The CU further sends a UE Context Setup Request to the Candidate Target DU to request relevant data, e.g. LTM-CSI-Resource Set, LTM Reporting Config, Meas Gap Config, etc., and filtering criteria for determining relevant data. Once the requested data is received the CU generates a corresponding LTM measurement related configuration, including e.g. filtering criteria for cells to enable UE to determine relevant data therefrom. The filtering criteria may relate to default filtering criteria for each cell for LTM meas, and/or default sub-set of LTM cells for beam measurements for C1 and C2. The CU forwards the LTM measurement configuration or parts thereof or part of the generated data to the UE, the Source DU and the Candidate Target DU. The UE is thus enabled to determine relevant measurement parameters to perform LTM related measurements and report them to Source DU. Source DU is anebled to update at least some parameters and send the updated parameters to the UE. UE is then enabled to use the updated parameters to perform adapted measurements. When Source DU sends a cell change/cell switch command to UE to perform handover to target cell C2, UE switches meas gap and report config to C2. This way UE is enabled to send adapted measurement results directly after cell switch to target cell C2 (new serving cell), e.g. without the need of a preconfiguring by target cell C2. Target cell C2 can however update at least one parameter, e.g. bitmaps of LTM Config Indices and RSs after cell switch to enabled even better measurements.

For both implementation examples, e.g. FIGS. 4 and 5: For the simple illustration, only one target cell (C2) is shown in this figure. The proposed solution, however, is applicable for multiple target cells which can be either under the same DU or different DUs. In that case, the steps 5, 6 and 10 in FIG. 4 and steps 5, 6, and 9 in FIG. 5 should be repeated for those target cells.

Further one or more of the following advantages might be achieved depending on the circumstances and the implementation variant:
Minimal RRC configuration changes to L1 measurement and reporting configuration for LTM in dynamic switching
Dynamic activation/deactivation of appropriate set of candidate target cells and associated RSs for LTM L1 measurements
Both network and UE based solutions are provided
Inter-frequency L1 measurements for LTM can be enabled

### Exemplary List of Abbreviations

ARFCN Absolute Radio Frequency Channel Number
BWP Bandwidth Part
CSI Chanel State Information
CSI-RS Channel State Information Reference Signal
CU Centralized Unit
DCI Downlink Control Information
DU Distributed Unit
ICBM Inter Cell Beam Management
L1 Layer 1
L2 Layer 2
LTM L1/2-triggered Mobility
MAC Medium Access Control
NW Network
RRC Radio Resource Control
RS Reference Signal
RSRP Reference Signal Received Power
PUCCH Physical Uplink Control Channel
PUSCH Physical Uplink Shared Channel
SSB Synchronization Block
UE User Equipment

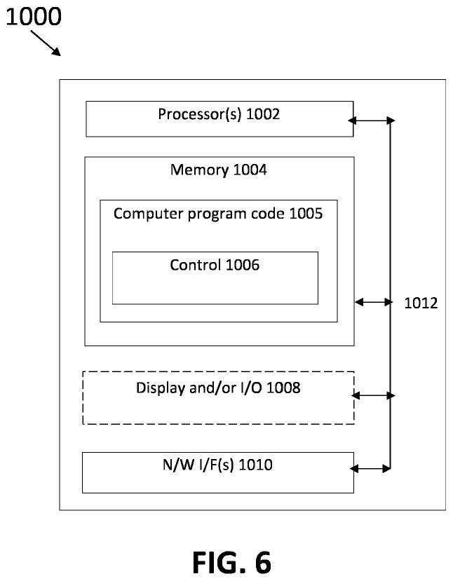

FIG. 6 schematically illustrates an example apparatus configured to implement at least one example described herein.

FIG. 6 is an example apparatus 1000, which may be implemented in hardware, configured to implement the examples described herein. The apparatus 1000 comprises at least one processor 1002 (e.g., an FPGA and/or CPU), at least one memory 1004 including computer program code 1005, wherein at the least one memory 1004 and the computer program code 1005 are configured to, with at least one processor 1002, cause the apparatus 1000 to implement circuitry, a process, component, module, or function (collectively control 1006) to implement the examples described herein, including enabling using per-target-cell CU-UP in CPA/CPC initiation.

The apparatus 1000 optionally includes a display and/or I/O interface 1008 that may be used to display aspects or a status of the methods described herein (e.g., as one of the methods is being performed or at a subsequent time), or to receive input from a user such as with using a keypad, touchscreen, touch area, microphone, biometric recognition circuitry, etc. The apparatus 1000 includes one or more network (N/W) interfaces (I/F(s)) 1010. The N/W I/F(s) 1010 may be wired and/or wireless and communicate over the Internet/other network(s) using any communication technique. The N/W I/F(s) 1010 may comprise one or more transmitters and one or more receivers. The N/W I/F(s) 1010 may comprise standard well-known components such as an amplifier, filter, frequency-converter, (de)modulator, and encoder/decoder circuitries and one or more antennas.

The apparatus 1000 to implement the functionality of control 1006 may be the UE (110), RAN node 170, network element(s) 190, or any of the other items depicted in a previous FIG. such as the UE 110, MN 170, SN1-CU-CP 196-1, SN1-CU-UP1 196-2, SN1-CU-UP2 196-3, S-GW 190-1, MME 190-2, UPF 190-3, CU-CP1 796, CU-CP1 896, and apparatus 900. Apparatus 1000 may be part of a self-organizing/optimizing network (SON) node, such as in a cloud. The apparatus 1000 may also be distributed throughout the network 100 including within and between apparatus 1000 and any network element (such as a network control element (NCE) 190 and/or the RAN node 170 and/or the UE 110) including the network elements depicted in previous figures.

Interface 1012 enables data communication between the various items of apparatus 1000, as shown in FIG. 6. For example, the interface 1012 may be one or more buses such as address, data, or control buses, and may include any interconnection mechanism, such as a series of lines on a motherboard or integrated circuit, fiber optics or other optical communication equipment, and the like. Computer program code 1005, including control 1006 may comprise object-oriented software configured to pass data/messages between objects within computer program code 1005. The apparatus 1000 need not comprise each of the features mentioned, or may comprise other features as well.

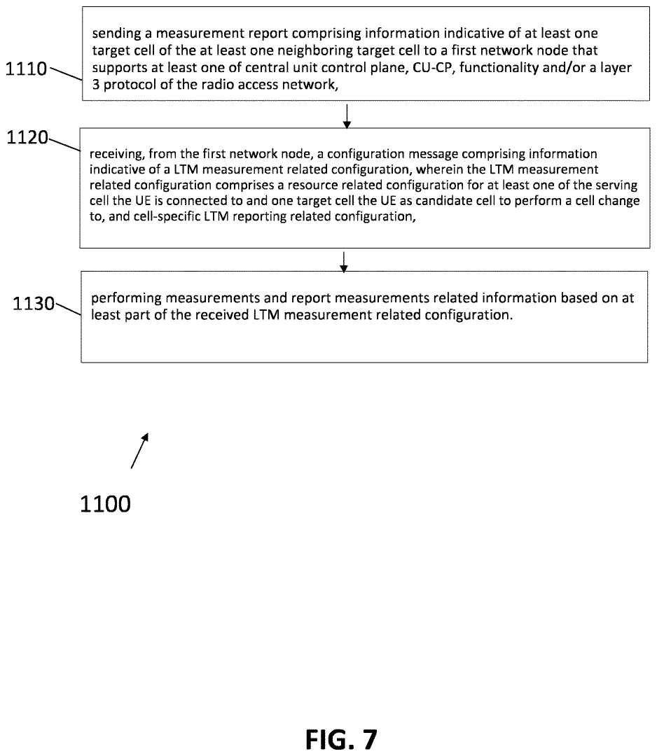

FIG. 7 schematically illustrates an example of a method to implement at least one example described herein.

FIG. 7 is an example method 1100 for configuring a
user equipment, UE, configured for supporting connection towards a radio access network including at least a first network node. To implement the method the UE may comprise:
at least one processor; and
at least one memory storing instructions that, when executed by the at least one processor, cause the UE at least to perform at least some of the method steps below:

At 1110, the method includes sending a measurement report comprising information indicative of at least one target cell of the at least one neighboring target cell to a first network node that supports at least one of central unit control plane, CU-CP, functionality and/or a layer 3 protocol of the radio access network,
at step 1120 the method includes receiving, from the first network node, a configuration message comprising information indicative of a LTM measurement related configuration, wherein the LTM measurement related configuration comprises a resource related configuration for at least one of the serving cell the UE is connected to and one target cell the UE as candidate cell to perform a cell change to, and cell-specific LTM reporting related configuration,
at step 1130 the method includes performing measurements and report measurements related information based on at least part of the received LTM measurement related configuration.

To implement the method the UE may comprise specific means to perform specific functions/tasks, e.g. to perform one or more of the listed steps above the UE may include establishing means, receiving means, determining means, acquisition means, and/or montoring means. The specific means may be implemented using hardware and/or software, e.g. specific circuitry and/or specific computer program code.

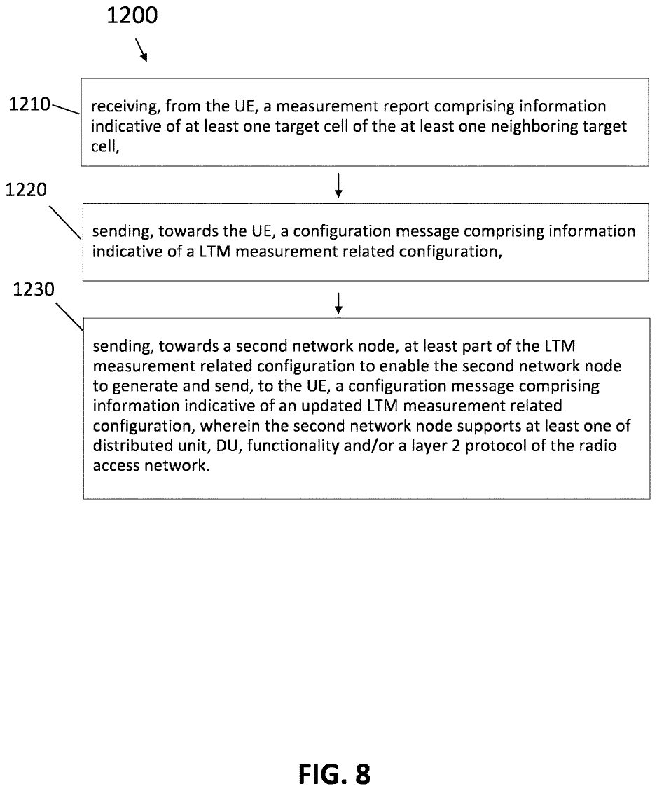

FIG. 8 schematically illustrates an example of a method to implement at least one example described herein.

FIG. 8 is an example method 1200 for configuring a first network nodeconfigured to support at least one of central unit control plane, CU-CP, functionality and/or a layer 3 protocol of the radio access network for controlling a user equipment, UE, configured for supporting connection towards a radio access network including at least the first network node. To implement the method the first network node (source DU) may comprise:
at least one processor; and
at least one memory storing instructions that, when executed by the at least one processor, cause the first network node (source DU) at least to perform at least some of the method steps below:

At step 1210, the method includes:
receiving, from the UE, a measurement report comprising information indicative of at least one target cell of the at least one neighboring target cell,
at step 1220 the method includes sending, towards the UE, a configuration message comprising information indicative of a LTM measurement related configuration,
at step 1230 the method includes sending, towards a second network node, at least part of the LTM measurement related configuration to enable the second network node to generate and send, to the UE, a configuration message comprising information indicative of an updated LTM measurement related configuration, wherein the second network node supports at least one of distributed unit, DU, functionality and/or a layer 2 protocol of the radio access network.

To implement the method the first network node may comprise specific means to perform specific functions/tasks, e.g. to perform one or more of the listed steps above the first network node may include establishing means, receiving means, determining means, acquisition means, and/or montoring means. The specific means may be implemented using hardware and/or software, e.g. specific circuitry and/or specific computer program code.

It should nevertheless be noted that the apparatus (device) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the CU, the DU, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

Yet in some other example embodiments, there is provided a respective apparatus (e.g., implementing the UE, the CU, the DU, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also to be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

1. A user equipment, UE, configured for supporting connection towards a radio access network including at least a first network node, wherein the UE comprises:
at least one processor; and
at least one memory storing instructions that, when executed by the at least one processor, cause the UE at least to:
send a measurement report comprising information indicative of at least one target cell of the at least one neighboring target cell to a first network node that supports at least one of central unit control plane, CU-CP, functionality and/or a layer 3 protocol of the radio access network,
receive, from the first network node, a configuration message comprising information indicative of a LTM measurement related configuration, wherein the LTM measurement related configuration comprises a resource related configuration for at least one of the serving cell the UE is connected to and one target cell the UE as candidate cell to perform a cell change to, and cell-specific LTM reporting related configuration,
perform measurements and report measurements related information based on at least part of the received LTM measurement related configuration.

2. A user equipment, UE, according to claim 1, wherein the resource related configuration includes a common or reference LTM-Meas Config related at least to the serving cell and one target cell.

3. A user equipment, UE, according to claim 1, wherein the resource related configuration includes an LTM-CSI Resource Set related at least to the serving cell and one target cell.

4. A user equipment, UE, according to claim 1, wherein the LTM reporting related configuration includes at least one of: LTM-Reporting Config, Measurement Gap, bitmap of activated LTM Config Indices and/or RSs for at least one of the serving cell and one target cell.

5. A user equipment, UE, according to claim 1, wherein the UE is further configured to
receive, from a second network node, a configuration message comprising information indicative of an updated LTM measurement related configuration, wherein the second network node supports at least one of distributed unit, DU, functionality and/or a layer 2 protocol of the radio access network.

6. A user equipment, UE, according to claim 5, wherein the UE is further configured to:
determine resources for performing measurements based on the received updated configuration,
perform measurements, and
report measurements related information towards the second network node.

7. A user equipment, UE, according to claim 1, wherein the LTM reporting related configuration includes a default bitmap of activated LTM Config Indices and RSs for at least one of the serving cell and one target cell, and wherein the UE is further configured to:
receive, from a second network node, a configuration message comprising an updated bitmap of activated LTM Config Indices and/or RSs for at least one of the serving cell and one target cell, wherein the second network node supports at least one of distributed unit, DU, functionality and/or a layer 2 protocol of the radio access network.

8. A user equipment, UE, according to claim 1, wherein the UE is further configured to:
report measurements related information towards a second network node, wherein the second network node supports at least one of distributed unit, DU, functionality and/or a layer 2 protocol of the radio access network,
receive, from the second network node, a cell switch command to perform a cell change to a target cell,
perform handover to the target cell,
determine cell-specific measurement parameters for the target cell based on the cell-specific LTM reporting related configuration,
perform measurements based on the received common LTM-Meas Config and the determined cell-specific LTM-Reporting Config parameters for the target cell,
report measurement related information towards a third network node supporting the target cell, wherein the third network node supports at least one of distributed unit, DU, functionality and/or a layer 2 protocol of the radio access network.

9. A user equipment, UE, according to claim 1, wherein the LTM measurement related configuration includes filter criteria for LTM meas for at least of serving cell and target cell.

10. A user equipment, UE, according to claim 1, wherein the LTM measurement related configuration includes a default sub-set of LTM cells for beam measurement for at least of serving cell and target cell.

11. A user equipment, UE, according to claim 9, wherein the UE is further configured to:
determine resources, in particular LTM-CSI related, for performing measurements based on the received filter criteria.

12. A user equipment, UE, according to claim 11, wherein the UE is further configured to
receive, from a second network node, a configuration message comprising information indicative of an updated LTM measurement related configuration including updated filter criteria, wherein the second network node supports at least one of distributed unit, DU, functionality and/or a layer 2 protocol of the radio access network,
determine resources, in particular LTM-CSI related, for performing measurements based on the received updated filter criteria,
perform measurements, and
report measurements related information towards the second network node.

13. A user equipment, UE, according to claim 1, wherein the UE is further configured to:
report measurements related information towards a second network node, wherein the second network node supports at least one of distributed unit, DU, functionality and/or a layer 2 protocol of the radio access network,
receive, from the second network node, a cell switch command to perform a cell change to a target cell,
perform handover to the target cell,
determine cell-specific measurement parameters for the target cell based on the cell-specific LTM reporting related configuration including filter criteria for the target cell,
perform measurements based on the determined cell-specific parameters,
report measurement related information towards a third network node supporting the target cell, wherein the third network node supports at least one of distributed unit, DU, functionality and/or a layer 2 protocol of the radio access network.

14. A user equipment, UE, configured for supporting connection towards a radio access network including at least a first network node, wherein the UE comprises:
at least one processor; and
at least one memory storing instructions that, when executed by the at least one processor, cause the UE at least to:
send a measurement report comprising information indicative of at least one target cell of the at least one neighboring target cell to a first network node that supports at least one of central unit control plane, CU-CP, functionality and/or a layer 3 protocol of the radio access network,
receive, from the first network node, a configuration message comprising information indicative of a LTM measurement related configuration,
receive, from a second network node, a configuration message comprising information indicative of an updated LTM measurement related configuration, wherein the second network node supports at least one of distributed unit, DU, functionality and/or a layer 2 protocol of the radio access network.

15. A user equipment, UE, according to claim 14, wherein the LTM measurement related configuration includes filter criteria for at least one of serving cell and target cell, and wherein the updated LTM measurement related configuration includes updated filter criteria for at least one of serving cell and target cell.

16. A user equipment, UE, according to claim 14, wherein the LTM measurement related configuration includes cell specific default bitmaps of activated LTM Config Indices for at least one of serving cell and target cell, and wherein the updated LTM measurement related configuration includes updated cell specific bitmaps of activated LTM Config Indices for at least one of serving cell and target cell.

17. A user equipment, UE, configured for supporting connection towards a radio access network including at least a first network node, wherein the UE comprises:
at least one processor; and
at least one memory storing instructions that, when executed by the at least one processor, cause the UE at least to:
send a measurement report comprising information indicative of at least one target cell of the at least one neighboring target cell to a first network node that supports at least one of central unit control plane, CU-CP, functionality and/or a layer 3 protocol of the radio access network,
receive, from the first network node, a configuration message comprising information indicative of a LTM measurement related configuration, wherein the LTM measurement related configuration comprises information to derive parameters for a cell specific measurement related the serving cell the UE is connected to and cell specific parameters related to one target cell,
determine parameters for a cell specific measurement related to the serving cell,
perform measurements based on the determined parameters,
report measurements related information towards a second network node supporting the serving cell, wherein the second network node supports at least one of distributed unit, DU, functionality and/or a layer 2 protocol of the radio access network.
receive, from the second network node, a cell switch command to perform handover to a target cell supported by a third network node, wherein the third network node supports at least one of distributed unit, DU, functionality and/or a layer 2 protocol of the radio access network,
perform handover to the target cell,
determine parameters for a cell specific measurement related to the target cell,
perform measurements based on the determined parameters, and
report measurements related information towards a third network node.

18.-27. (canceled)
